(19) United States
(12) Patent Application Publication
(10) Pub. No.: US 2005/0289015 A1
(43) Pub. Date: Dec. 29, 2005

(54) System and method permitting merchants to use electronic billboard displays to carry advertisements for products that can be purchased through a universal, automated order processing system

(76) Inventors: Charles Eric Hunter, Hilton Head Island, SC (US); Robert D. Summer, New Preston, CT (US); Kelly C. Sparks, Raleigh, NC (US); Ollin B. Sykes, Edenton, NC (US); John H. Hebrank, Durham, NC (US)

Correspondence Address: FROST BROWN TODD, LLC, 2200 PNC CENTER, 201 E. FIFTH STREET, CINCINNATI, OH, 45202, US

(21) Appl. No.: 10/663,718

(22) Filed: Sep. 17, 2003

Related U.S. Application Data
(63) Continuation of application No. 09/465,730, filed on May 17, 2000, now abandoned.

(51) Int. Cl. H04N 7/16

(52) U.S. Cl. 705/27

(57) ABSTRACT

Merchants directly access a network of thousands of large, high resolution electronic billboard displays and directly send their own advertisements electronically to the network to be displayed at locations and times they select. The advertisements include order numbers that may be used by consumers to order the advertised products and product information through a universal, automated order processing system that represents many merchants.

### FIELD OF THE INVENTION

The invention relates to merchandising through the display of video or still image content on electronic displays. More particularly, the invention relates to merchandising through a network of multiple (e.g., thousands) of large, high resolution electronic billboard displays. Merchants place advertisements on the displays so that the advertised products are tied into a universal, automated order processing system that represents many merchants.

### BACKGROUND OF THE INVENTION

Background—Billboard Advertising

Consumer product advertising takes many forms, such as television commercials, newspaper and magazine advertisements, mailings, point-of-purchase displays, outdoor billboards, etc. Using current advertising media, advertisers engage in a constant struggle to efficiently use their budgets to most effectively reach their geographic and demographic targets.

Focusing on the outdoor advertising component of advertising by consumer product companies, it is well known that outdoor billboards have traditionally taken the form of single-message displays formed of printed sheets or painted surfaces containing the advertising content adhered to a flat backing. This time-honored outdoor advertising technique has remained essentially unchanged throughout the twentieth century. The high cost of printing, transporting and mounting a message on a conventional billboard has dictated that the same message remain in place for a considerable period of time. Thus, a conventional billboard cannot be readily changed to reflect current events within the geographic area of the billboard. Additionally, the content on a conventional billboard tends to become essentially “invisible” as a part of the landscape after its content has been in place for a relatively short period of time, especially to commuters and others who regularly pass the billboard. Beyond the above problems with cost, single-message content, lack of content changeover capability, and the like, conventional outdoor billboards have come under increasing criticism because in their large numbers, and often tattered condition, they clutter highways with a distasteful form of visual “pollution”. A reduction in the number of billboards and improvement of the appearance and profitability of those that remain, if accomplished while increasing the overall advertising impact afforded by outdoor advertising, would please virtually everyone.

The use of electronic billboards has been suggested, for example, in U.S. Pat. No. 5,612,741. However, there is no electronic billboard network in operation whereby commercial advertisers may directly place ads onto selected billboards at selected times through direct access to a master network. Such a network, properly designed and operated, promises to overcome the numerous disadvantages currently associated with the outdoor advertising industry, while also meeting the above needs of consumer products advertisers.

Background—Consumer/Merchant Product Purchase Transactions

Over time, consumer/merchant product purchase transactions have evolved from early barter-type transactions to the three forms of transactions that predominate in the modern economy.

First are face-to-face transactions (for example, involving the customer and a retail store, street vendor, or the like) where payment is made by cash, bank check or credit card. While these face-to-face transactions will always be a part of the economy, they are generally limited to those products that are readily available for exchange at the site of the transaction.

Secondly are conventional “mail order” purchases typically made by telephone calls to operators representing the mail order company. These purchases are usually made through catalog services, but may be through a retail store or, in a TV marketing context, through a vendor that has advertised on television. Payment for these types of purchases are usually by bank check or credit card, with credit card payment being preferred to avoid delays occasioned by mailing the customer's check to the merchant and “clearing” of the check through the banking system. Deliveries of mail order purchases are usually by common carrier, such as United Parcel Service, Federal Express, or the like. While mail order services greatly enhance customer options and provide a convenience, the cost of order processing may exceed 20% of sales due in large part to the high cost of the necessary telephone operators. Additionally, in times of low unemployment and with the expected changing demographics of the work force, it is likely to be exceedingly difficult to recruit and retain workers in sufficient numbers at reasonable wages and with sufficient skills to maintain the current cost structures of retail mail order processing.

The third form of consumer/merchant transactions in the modern economy is purchasing through computers that are interconnected through communication links, for example, orders of products over the Internet. Internet purchases are almost exclusively paid for by credit cards. Drawbacks to the current Internet purchasing model include the occasional difficulties in logging on as well as the unfamiliar and cumbersome process necessary to page through an electronic catalog, often resulting in enough frustration that potential purchasers simply do not attempt the effort. Vast numbers of “computer savvy” consumers simply refuse to use Internet purchasing systems for these reasons. Additionally, there is the problem of sensitive information, primarily credit card numbers, being routed through the nodes of computer systems that are located throughout the world. Large numbers of computer savvy customers refuse to use the Internet purchasing systems for security reasons alone. As another consideration, the entire Internet purchasing model is brought into question by the well-documented financial losses on operations suffered by this segment of the economy. Published reports indicate that the 241 largest retail Internet merchants in the United States are currently losing approximately seven billion dollars per year on net sales of 20 billion dollars per year—bringing into question the viability of the Internet based retail selling business model. Lastly, vast numbers of people, currently a substantial majority of consumers in the United States, simply do not have home-based access to the Internet or do not have the computer skills or confidence to engage in Internet purchase transactions. While optimistic projections see this problem declining over time, there clearly is a ceiling on the percentage of the population who will use this model even five or ten years in the future. As evidence of the reluctance of a solid core of citizens to use Internet ordering either now or in the future is the fact that only fifteen to twenty percent of video cassette recorder (VCR) purchasers learn to program their VCR's to record programming for time shifting purposes—or even master the steps necessary to set the VCR's clock.

Another issue not addressed by promoters of the Internet model for consumer purchase transactions is the inability of relatively small vendors to offer products independently without the significant overhead attributed to the so-called “back office operations” associated with order processing. An order processing system that would permit small vendors to economically and efficiently process orders would open up a limitless number of business opportunities and further enhance choice and price competition to the benefit of consumers and the economy as a whole.

Telephone technology appears to have been largely overlooked in the current rush to Internet based consumer product purchase transactions. Telephone access is essentially universal in developed countries throughout the world, with compatible protocols and systems interconnecting the entire globe. Telephones are easy to use and become more so every day. Virtually everyone is comfortable with telephone communications and appreciates the convenience they afford. The versatility and options offered by telephones are ever expanding, while the cost of calls is dropping dramatically. Long distance toll charges in the year 2010, including international calls, are likely to drop to on the order of one to three cents per minute, with many calls close to being free. Cellular phones are becoming so small that they may be carried in even the smallest purse, and with further miniaturization, cellular phones will be carried with the ease of a credit card. Lastly, and importantly, the phone system offers a level of security to the information transmitted, whether voice or data, that is sufficient to meet the requirements of the most security sensitive consumers and merchants.

With the advent of electronic billboard displays and the new and unique capabilities they afford advertiser-merchants, it would be desirable to utilize these billboard displays in conjunction with a new universal, automated product ordering system that overcomes the above-described drawbacks associated with the current models for product purchase transactions.

### SUMMARY OF THE INVENTION

The present invention, in one broad aspect, is a system whereby merchants place video or still-image advertisements at selected times on a network of multiple electronic billboard displays, and include in the advertisements product order numbers that permit customers of a central order processing system to place orders for the products.

According to the electronic billboard display aspect of the invention, merchants and the advertising agents that represent them, directly access a network of multiple, large, high resolution electronic displays located in high traffic areas and directly send their own advertisements electronically to the network to be displayed at locations and times selected by the advertisers. The advertisements include a unique product order number for each advertised product so that the order number may be used by consumers to purchase products through the ordering system described below. In preferred embodiments, a central information processing center permits merchants who are billboard network customers to review a schedule of times and electronic display locations that are available for placement of advertisements, and also permits them to purchase available times at selected electronic display locations for placement of their advertising content. The merchant then transmits his video or still image advertising content to the processing center where the content is reviewed for appropriateness and then transmitted to the customer-selected electronic display(s). The electronic displays preferably are large (e.g., 23×33½ ft.) flat LED displays that are driven by their own video or image servers.

The order processing aspect of the invention permits ordinary consumers to set up accounts with an order processing system and thereafter order products from a vast array of products offered by the participating merchants who advertise their respective products on the electronic billboard network. Of course, the order processing system may be structured to accept orders for products that are advertised through other media, as well. The array of products is limitless, subject only to the level of participation by the merchants who offer products. Access to the order processing system is made quick and simple so that virtually anyone will feel comfortable using the system. In certain embodiments, orders can be placed by a telephone call, preferably a call dialed by pressing a single button, followed by the system automatically identifying the call by call no. ID, voice verification, or both, followed by the customer simply entering the product number for the product desired. The order is automatically processed by the system and a processed order is automatically routed in electronic form to the participating merchant who will fulfill the order without further need for contact with the consumer. Either the participating merchant or the operator of the order processing system may assume responsibility for verifying available credit at the time of the purchase. The operator of the system may also offer revolving credit. The system may also be used to automatically provide customers with free product information by e-mail, mail or telephone.

### BRIEF DESCRIPTION OF THE DRAWINGS

Some of the features of the invention having been stated, other features will appear as the description proceeds, when taken in connection with the accompanying drawings, in which—

FIG. 1 is a block diagram showing the principal components of an electronic billboard display network used by advertiser-merchants to advertise their products with product order numbers.

FIG. 2 is a view of one of the electronic displays of the network of FIG. 1.

FIG. 3 is a block diagram showing one product ordering system.

FIG. 3A shows an advertisement for a product available through the ordering system of FIG. 3.

FIG. 3B shows a shipment choice narrative associated with the embodiment of FIG. 7.

FIGS. 4-8 show automated product ordering systems similar to that of FIG. 3 but including additional or modified features.

FIG. 9 shows a roadside electronic billboard advertising a product that can be ordered through the automated product ordering system of the invention.

FIG. 10 shows another roadside electronic billboard advertising a pizza special for delivery to a commuter's home to arrive at about the time that the commuter returns home in the evening.

FIG. 11 is a block diagram showing a business model for commercial exploitation of the order processing system.

FIG. 12 shows another electronic billboard display that presents an advertisement for switching telephone service.

FIG. 13 shows a representative order number hierarchy based on codes having a maximum length of 10 digits.

### DETAILED DESCRIPTION OF THE INVENTION

While the present invention will be described more fully hereinafter with reference to the accompanying drawings, in which aspects of the preferred manner of practicing the present invention are shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

As discussed above, the invention utilizes a network of electronic billboard displays for displaying merchants' advertisements for products that are available for ordering, via product order numbers, from a universal, automated order processing system that represents many (e.g., hundreds or thousands) participating merchants. The electronic billboard display network will be described first, followed by a description of the order processing system and the manner in which the billboard network and order processing system work together to benefit consumers, merchants and the economy as a whole.

The Network of Electronic Billboard Displays

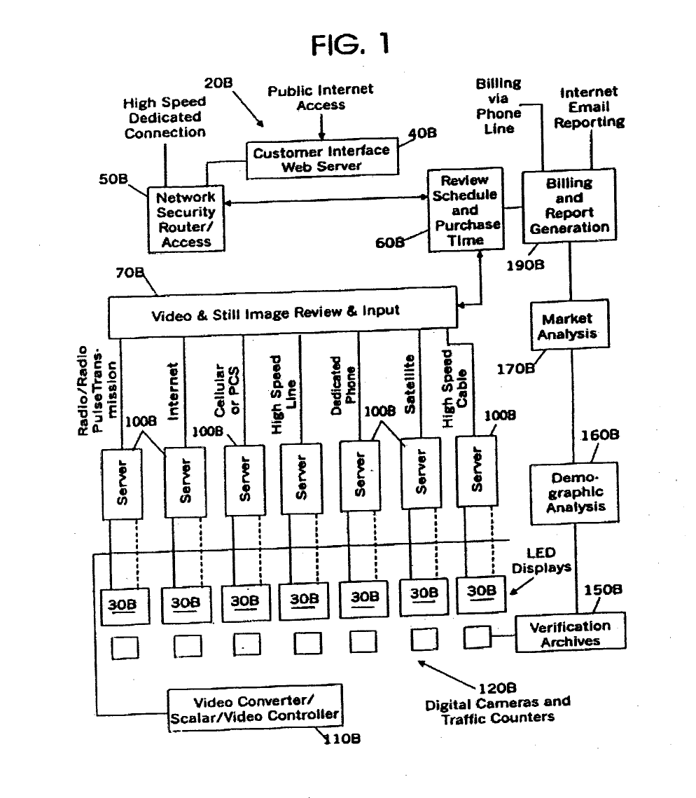

Referring to the drawings, and particularly to FIG. 1, there is shown a block diagram of a system 20B for direct placement of participating merchants' advertisements (that include the above-described product order numbers) on electronic billboard displays. System 20B includes a network comprising a plurality of electronic billboard displays 30B that are located in high traffic areas in various geographic locations. The displays may be located in areas of high vehicular traffic, and also at indoor and outdoor locations of high pedestrian traffic, as well as in movie theaters, restaurants, sports arenas, casinos or other suitable locations. Thousands of displays, up to 10,000 or more displays worldwide, may be networked according to the present invention. In preferred embodiments, each outdoor billboard display is a large (for example, 23 feet by 33½ feet), high resolution, full color display that provides brilliant light emission from a flat panel screen.

A merchant-advertiser that is a customer of system 20, as represented for example by an in-house or agency representative, may access a central information processing station of system 20B via the Internet through a Customer Interface Web Server 40B. The customer interface web server has a commerce engine and permits the advertiser-merchant to obtain and enter security code and billing code information into a Network Security Router/Access module 50B. Alternatively, high usage advertiser-merchants of the system may utilize a customer interface comprising a high speed dedicated connection to module 50B. Following access, the customer reviews options concerning his order by reviewing available advertising time/locations through a. Review Schedule and Purchase Time module 60B that permits the advertiser-merchant to see what time is available on any display throughout the world and thereafter schedule and purchase the desired advertising time slot. Next, the advertiser-merchant transmits the advertising content on-line through the Internet, a direct phone line or a high speed connection (for example, ISDN, or other suitable high speed information transfer line) for receipt by the system's Video & Still Image Review and Input module 70B. In parallel, the system operator may provide public service announcements and other content to module 70B. All content, whether still image or video, is formatted in NTSC, PAL, SECAM, YUV, YC, VGA or other suitable formats. In a preferred embodiment, the format is VGA, while all other formats, including but not limited to NTSC, PAL and SECAM, can be run through the video converter 110B.

The video & still image review and input module 70B permits a system security employee to conduct a content review to assure that all content meets the security and appropriateness standards established by the system, prior to the content being read to the server 100B associated with each display 30B where the content being transmitted to the server 100B will be displayed. Preferably, the servers are located at their respective displays and each has a backup. An example of a suitable server is the IBM RISC 6000 server.

The means for transmitting content information to the display locations may take a number of forms, with it being understood that any form, or combination thereof, may be utilized at various locations within the network. As shown in FIG. 1, the means include:
High speed cable
Satellite
Dedicated phone
High speed line (e.g., ISDN, ADSL)
Cellular, PCS or other data transmission at available frequencies
Internet
Radio/radio pulse transmission
High speed optical fiber
Physical delivery of digitally stored information medium.
   A video converter/scaler function and a video controller function provided by module 110B may be utilized in connection with those servers 100B and associated displays 30B that require them, according to data transmission and required reformatting practices well known in the art.

Verification that advertisements do, in fact, run at the intended time at the intended displays may be provided by an information storage module (not shown) linked to each display. Another form of verification may be achieved by a Digital Camera and Traffic Count Recorder 120B that continuously records the content appearing at its respective display 30B and digitally transmits video verification information to a Verification Archives module 150B. Recorder 120B also provides traffic count information (for example, 225 vehicles passed the display while an advertisement ran) to verification archives module 150B.

Information from verification archives module 150B is utilized by a demographic analysis module 160B and a market analysis module 170B to generate information for reports to be sent to customers after their advertisements run. To this end, analysis data from modules 160B and 170B is transmitted to a Billing and Report Generation module 190B where reports are assembled showing, for example, the time of the advertisement, the content of the advertisement, the traffic count and residence/median income information about those who saw the advertisement. A representative, simplified report for an advertisement running on a single display is as follows:

Customer: ABC Products Co.

Ad Content: Ocean Scene with graphics

(content code 1111)

Location: Atlanta, Georgia, Interstate

75N, milepost 125 (site code XXXX)

Time: 7:30 AM, Jun. 30, 2000
Vehicle Count: 225
Viewer Count: 340
Viewer Demographics:

50% Resident Cobb County, GA

Median household income: $60,000/yr.

30% Resident DeKalb County, GA

Median household income: $52,000/yr.

20% Median household income

$55,000/yr.
Advertising Cost: $X

advertisement that may have run at multiple displays, for example 100 displays, a representative report may appear as follows:

Customer: ABC Products Co.

Ad Content: Mountain Scene with graphics

(content code 2222)

Locations: 100 sites

(site codes YYY . . . ZZZ)

Time: 8:30 AM, Jul. 10, 2000
Total Vehicle Count: 21,500
Total Viewer Count: 37,200
Viewer Demographics:
Median household income, $49,500
Advertising Cost: $Y

Module 190B also produces bills that may be transmitted by phone lines for a debit payment such as a direct bank draft, or other suitable payment mode.

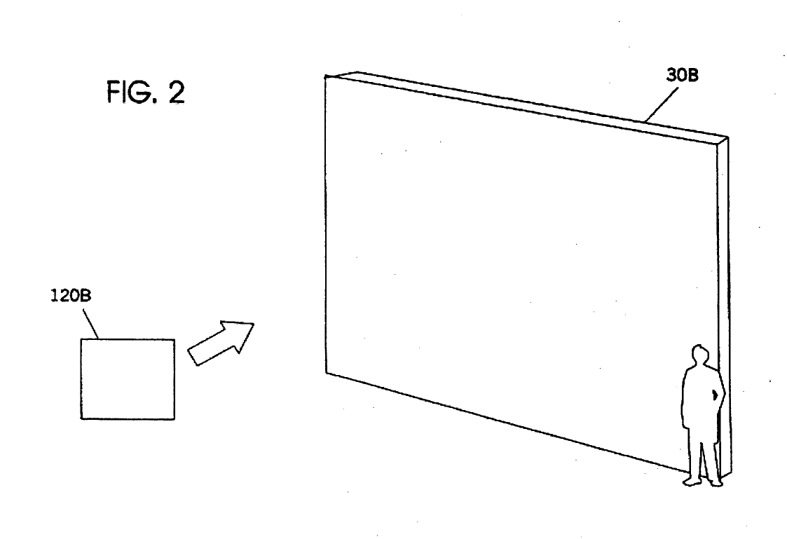

Referring to FIG. 2, there is shown a pictorial view of one preferred form for the electronic billboard displays 30B. In this embodiment, display 30B takes the form of a 23 feet by 33½ feet seamless flat screen display including multiple flat panel display modules. The panels utilize advanced semiconductor technology to provide high resolution, full color images utilizing light emitting diodes (LED's) with very high optical power (1.5-10 milliwatts or greater) that are aligned in an integrated array with each pixel having a red, green and blue LED. It will be appreciated that multiple LED's of a given color may be used at pixels to produce the desired light output; for example, three 1.5 milliwatt blue LED's may be used to produce a 4.5 milliwatt blue light output. Each red, green and blue emitter is accessed with 24 bit resolution, providing 16.7 million colors for every pixel. An overall display of 23 feet by 33½ feet, so constructed, has a high spatial resolution defined by approximately 172,000 pixels at an optical power that is easily viewable in bright sunlight. Suitable display modules for displays 30B are manufactured by Lighthouse Technologies of Hong Kong, China, under Model No. LV50 that utilize, for blue and green, InGaN LED's fabricated on single crystalline Al₂O₃ (sapphire) substrates with a suitable buffer layer such as AlN and, for red, superbright AlInGaP LED's fabricated on a suitable substrate such as GaP. These panels have a useful life in excess of 50,000 hours, for example, an expected life under the usage contemplated for network 20B of 150,000 hours and more. In preferred embodiments, the panels are cooled from the back of the displays, preferably via a refrigerant-based air conditioning system (not shown) such as a forced air system or a thermal convection or conduction system. Non refrigerant-based options may be used in locations where they produce satisfactory cooling. The displays preferably have a very wide viewing angle, for example, 160.

While the Lighthouse Technologies displays utilize the InGaN on sapphire and AlInGaP on GaP LED's described above (and in certain cases InGaN on SiC), other materials may be used for the LED's as follows:
I. (Blue/green) InGaN on SiC, preferably with a suitable buffer layer such as AlN
II. (Blue/green) InGaN on GaN
III. (Blue/green) InGaN on AlN, preferably with a suitable buffer layer such as AlN.
IV. (Blue/green) AlN or AlN-containing compound on AlN, sapphire or SiC.
   It will be appreciated that the InGaN on sapphire and the other solid state LED's described above have substrates with high optical transmissivity and produce very high optical power. This is important for a number of reasons, including giving the electronic display designers the ability to create very wide viewing angles up to approximately 160 and the resultant increase in visibility of the displays to viewers in oncoming traffic.

In addition to the particular solid state LED's mentioned above, the discrete sources of blue, green and red light at each pixel may take other forms such as composite devices including an ultraviolet LED that is utilized to excite a phosphor that, in turn, produces light of a selected spectrum. The ultraviolet LED may be formed from a GaN or GaN-containing compound on sapphire with or without suitable buffer layer, or a GaN or GaN-containing compound on SiC, preferably with a suitable buffer layer, or an AlN or AlN-containing compound on AlN, sapphire, SiC or GaN, with or without a suitable buffer layer. In one embodiment, ultraviolet LED's are incorporated into three different composite devices, each with a different phosphor for producing blue, green and red, respectively. In another embodiment, a phosphor is selected to produce white light and a desired color is produced by passing the white light through a band pass filter. According to this white-light embodiment, filters of blue, green and red may be used to create discrete composite devices that produce blue, green and red light at each pixel. The use of white light with appropriate band pass filters has the advantage of producing a colored light with an excellent wave length distribution that will not change appreciably over time, a desirable property for color balancing. On the other hand, the use of three different phosphors to directly produce blue, green and red without a filter has the advantage of higher efficiency because light is not filtered out. Both approaches have the advantage of excellent persistence which, as known in the art, is a desirable feature that is especially important in video applications.

It will be appreciated that energy sources other than ultraviolet LED's may be used to excite the phosphors of the composite devices discussed immediately above.

In the case of low ambient light applications, such as digital movie theaters, lower power LED's may be used. Furthermore, higher power LED's may be used to provide a light source for an LCD shutter-type screen as described in U.S. Pat. No. 5,724,062, incorporated herein by reference.

The provision of one or more high resolution, highly aligned digital cameras at each display site, for example the camera or cameras utilized in digital camera and traffic counter 120B, or other specifically dedicated cameras, provides a means permitting in situ diagnostics and calibration of the displays. As known in the art, certain digital cameras have a resolution of over 7,000,000 pixels—as compared to approximately 172,000 pixels on the above-described 23×33½ ft. display. Thus, by directing a digital camera at a display, or directing multiple digital cameras at different discrete portions of a display, a correspondence may be attained where a portion of each digital camera's image corresponds to a single pixel in the display. Suitable means for aligning the digital camera with the display is used, for example, optical means such as laser alignment marks. At selected times set aside for diagnostics and calibration, such as a five minute period each night, the entire display may be run red, then green, then blue, followed by white, all at multiple power levels. In order to reduce interference, the LED's may be switched on individually for a short period, for example one millisecond each. In the most basic diagnostic operation carried out when the display is run red/green/blue, the camera(s), mounted at a selected distance from the display such as sixty feet away, are capable of detecting nonfunctioning or excessively degraded LED's for replacement.

Beyond replacing defective LED's, each night the system may automatically re-calibrate all LED's in the display. To this end, the display is run red/green/blue at several iterative power levels (e.g., 20%/40%/60%/80%/100%) and the optical power output of each LED is sensed for each power level, with the goal being to calibrate the system so that each red, green or blue LED has the same optical power output at each power level as do the other LED's of the same color. Calibration preferably is achieved by diode recalibration scaler software (e.g., look up table) that may be associated with a scaler (not shown) that acts independently in conjunction with the video converter/scaler at 110B (FIG. 1). The diode recalibration scaler receives information from the diagnostic equipment indicating the optical power output of each LED at the various power levels and, through an associated automatic calibration LED look-up table, accounts for daily variance in LED output (degradation or increase) by adjusting the power curve by which the LED will be driven the next day. This periodic (e.g. daily) in situ recalibration has the benefit of greatly reducing on site maintenance since LED's that have degraded can be run harder to compensate for the degradation, eliminating the need for frequent replacement.

As an alternative to using digital cameras for the diagnostic and calibration function, in other embodiments miniature photodector chips, with or without band pass filters, may be located in close proximity to each LED in the display for measuring LED light output during diagnostic/calibration operations.

As another alternative, a programmable chip may be located at each pixel so that each individual chip may be reprogrammed as necessary during each calibration sequence to raise or lower the effective light output of the LED's contained in the pixel.

As an alternative to performing daily in situ calibration by looking at every pixel in sequence and adjusting the scaling value for each pixel, a statistical modeling approach may be utilized. According to this approach, selected LED'S or groups of LED's may be run in iterative power cycles in order to optimize the overall screen color through statistical analysis to provide a new scaling value for each LED or group of LED'S.

When the diagnostic operation operates with an all white display, the three LED's at each pixel may be evaluated individually and collectively to assure that the pixel is contributing the proper spectrum and amount of white light. Through a diagnostic/calibration software package that interrelates output and peak wave length response for each red/green/blue LED at a pixel to the desired white light response, an iterative calibration may be undertaken at each pixel to adjust the values contained in the diode recalibration scaler software or to reprogram programmable logic chips that determine the drive current for each LED located in a specific pixel.

It will be appreciated that split screen images may be displayed at the displays 30B. In the simplest application, a still image advertisement may be one half corporate logo and one half scenery. Beyond this simple application, split screen capability may be used to present a portion of the image as a corporate logo, or the like, and the remainder either real time (or near real time) video or still frame. For example, a previously qualified customer with acceptable internal content review procedures may have direct access to a display or displays for the purpose of displaying a real time (or near real time) sports event, news event, or the like, in conjunction with the customer's corporate logo. This display may be achieved by utilizing high speed servers 100B or by bypassing the servers altogether. High speed still image or video transfer may be facilitated by compression techniques such as JPEG and MPEG II, known in the art.

While advertising scheduling and purchasing may take place as described above where network customers directly purchase time from available slots according to a fixed fee schedule, it will be appreciated that alternative modes may be used. For example, an auction system such as introduced by eBay Corporation may be used where all previously purchased slots and all unsold slots are auctioned through a bid process (a “total” auction). Additionally, a limited auction may be utilized where time may be purchased and booked for a set price, but all time not purchased at the set price becomes available through auction at a fixed time before the run time, for example, one month before run time. As another alternative for a portion of the available time slots, a high usage network customer may establish a monthly advertising budget with the network system operator that authorizes the operator to select the time slots for display of the customer's advertisements at “best available rate” pricing, taking advantage of last minute availability of time slots and other time slot placement techniques that enable the operator to more completely utilize the network. This or similar time slot placement practices when used for a portion of the available time slots may be implemented by a software package that takes into account the needs of both the customer and the system operator.

It will be appreciated that advertising content information may be transmitted to the electronic display locations by physically delivering a suitable information storage device such as CD ROM, zip drive, DVD ROM or DVD RAM. This approach may be utilized to transmit information to displays at any desired location, for example, to remote locations, to movie theaters, etc.

The Automated Order Processing System as Used with the Above-Described Network of Electronic Billboard Displays

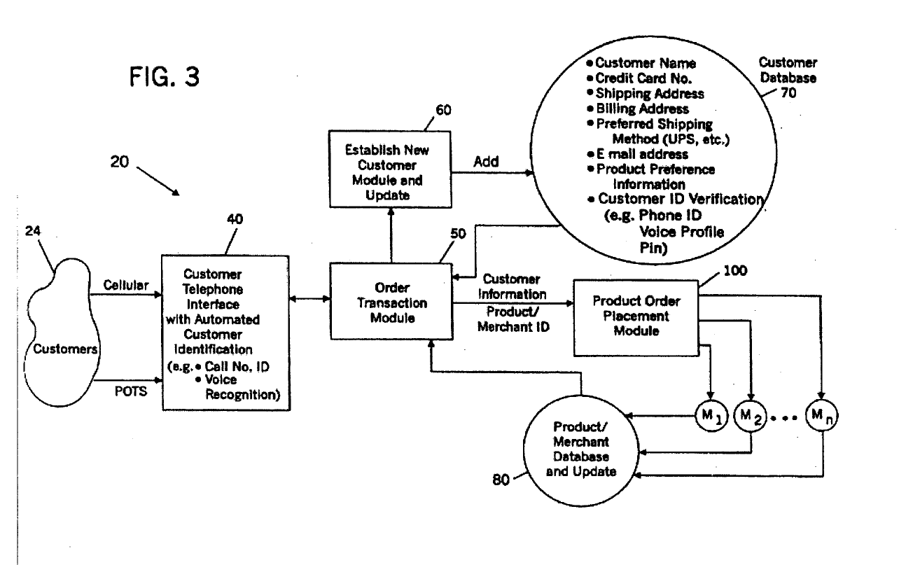

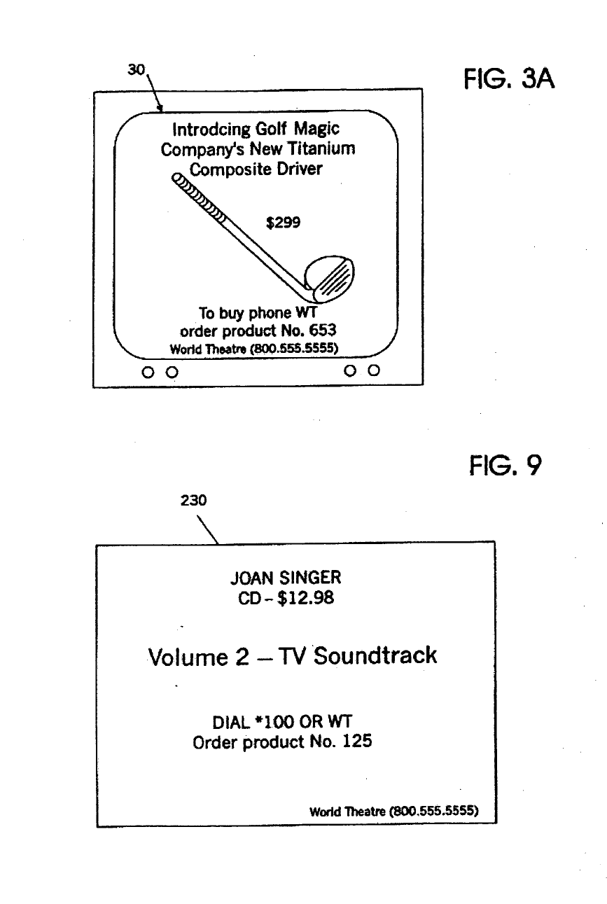

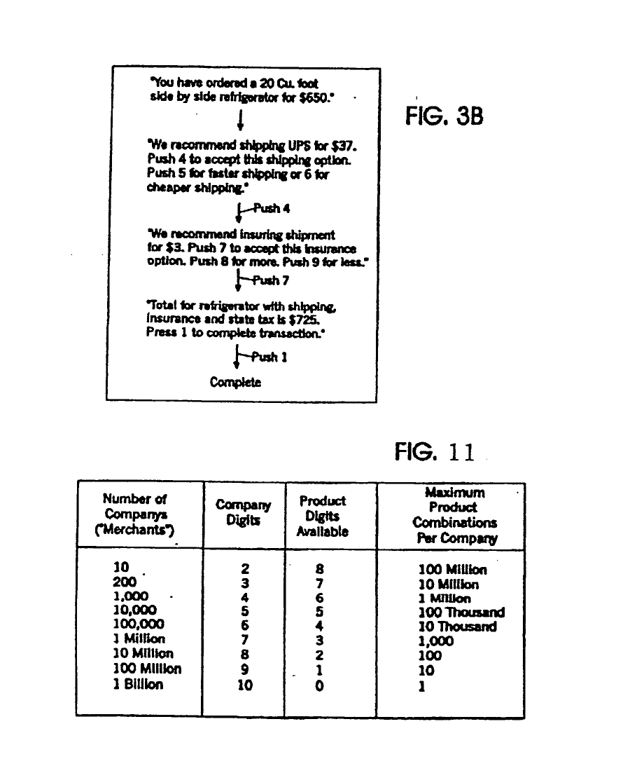

A brief overview of the operation of the automated order processing system of the invention will now be set forth from a customer's perspective, followed by a detailed description of the system, its components, alternative embodiments and other details of structure and operation. System 20 (FIG. 3) serves to automatically receive and process product orders from system customers 24 and route sufficient information to participating merchants M₁, M₂, . . . M_{N} so that the merchants can fulfill the orders. The participating merchants advertise their products through the above-described electronic billboard displays and, in certain embodiments, through other conventional advertising media such as catalogs, television, radio, newspapers, magazines, single message billboards, point of purchase displays, and the like. The advertisements include information indicating that the advertised products are available through system 20. The advertisements typically include a system address (e.g., a system telephone number accessible by a single preprogrammed button or speed dial). The advertisements also include a unique order number for each product that the merchants offer for sale through system 20. Referring to FIG. 3A, a representative advertisement 30 is shown that advertises a product (a golf club) offered for sale through system 20 by a participating merchant (Golf Magic Company). The advertisement includes the usual product information provided to inform and persuade potential customers, as well as the following notation:

### To Buy Phone WT Order Product No. 653

In this illustrative situation, system 20 is referred to as “WT”, the initials of the system operator, World Theatre. A full telephonic system address is also provided at the bottom of the advertisement by which the customer may access system 20 via a POTS (Plain Old Telephone System) toll-free “800” number. Additionally, a toll-free cellular linking number (not shown) may be provided. As mentioned above, it will be appreciated that the 800 number may be programmed into speed dial by customers of the “WT” system 20 or, in the alternative, telephones may be marketed with a single-touch keypad button labeled “WT” that automatically dials the system address of system 20. Likewise, cellular telephones may be programmed to speed dial either the 800 number or the cellular linking number, or provided with a single keypad button that automatically dials one of these numbers. The product order number 653 is a number assigned to the particular advertised product and serves also to identify the participating merchant who will fulfill orders for the product.

In a representative situation where a customer responds to advertisement 30, the customer using POTS dials or speed dials the 800 number of system 20 and connects to a customer telephone interface 40 that automatically identifies the customer by automated identification technology (e.g., “call no. ID”) or voice recognition technology or other suitable means. The customer then responds to a prompt from telephone interface 40 and enters the product order number. The customer may then hang up or await a confirmation and other ordering options that may be offered.

It will be appreciated that in preferred embodiments, first-time users of the system will need to supply sufficient information so that they may be identified and accepted as a customer in good standing, before they can place orders.

Referring now to FIG. 3, automated order processing system 20 includes a customer telephone interface 40 for receiving telephone calls from customers, an order transaction module 50, an establish new customer module 60 that communicates with module 50 and a customer database 70, a product/merchant database 80, and an order placement module 100 that communicates sufficient information to participating merchants M₁, M₂, . . . M_{N} to enable the merchants to fulfill orders. It will be appreciated that system 20 of FIG. 3 may be implemented utilizing a single computer system with data flow as shown or by multiple computers/databases accomplishing the same functions.

Customer telephone interface 40 serves as a means for receiving incoming product orders from customers who connect to the system via a system address, in this case a toll-free telephone number (e.g., 800.555.5555) or a cellular linking number (e.g., 100). To this end, telephone interface 40 includes a telephony switch from companies such as Nortel or Lucent Technologies, which identifies the inbound caller number and transmits that information to a receiving database server that automatically performs a lookup on the phone number to determine the caller's identity and required information (“call no. ID”). As an alternative to, or in addition to, call no. ID technology, the customer identity may be automatically determined by a voice recognition unit (VRU) that recognizes characteristics of a customer's voice and compares those characteristics to a voice profile that the customer provides when the customer is established as a new customer. VRU technology is commercially available from various vendors, for example, VRU systems marketed by VeriVoice, Inc. of Princeton, N.J., USA.

While it is preferred to utilize customer identification employing call no. ID technology, voice recognition technology or other technologies that operate independent of information input by the customer in response to a prompt, other identification means may be used, for example, where the customer is automatically prompted to provide information such as credit card number, social security number, date of birth, personal identification number (PIN), or the like, alone or in combination, and the provided information is compared against information previously established in the customer database to verify the identity of the customer placing the call. In this regard, the term “automatically identifying each customer placing an order” is deemed to include all of the above means for identifying customers and their equivalents, with it being understood that the technologies that do not require caller response to prompts are preferred.

Following identification of the customer placing a call, customer telephone interface 40 prompts the customer to enter the product order number (e.g., 653) for the product being ordered. The prompt may be as simple as a recognizable tone, or may be a simple verbal command such as “please enter (or say) product order number”. In a straightforward application, once the product order number is entered on the telephone keypad or stated verbally by the customer, the customer may hang up with or without interface 40 indicating acceptance of the order. In this regard, a suitable automated procedure following a customer's entry of an order number may be, “You have entered product number 653, a Golf Magic titanium composite driver. Please press 1 to complete your purchase of this product. Please press 2 to re-enter the product number.”. The system may permit ordering multiple products in one call, verifying the carrier to be used for shipping, verifying product availability and shipping date, and conveying other forms of information that consumers may desire during the order placement call. These features will be discussed below in conjunction with the description of other embodiments of the invention.

If the customer who is calling system 20 is a new customer who has not established an account with the system, the automated customer identification feature of customer telephone interface 40 will prompt the new customer to enter information sufficient to establish the caller as a qualified customer in customer database 70. In this regard, setting up a new customer file in customer database 70 may be achieved through an establish new customer module 60 that connects the caller to an operator or connects the caller to an automated new customer telephonic data entry application. According to the embodiment of FIG. 3, the information entered into the customer database may comprise:
customer name
credit card number
shipping address
billing address
preferred shipping method (UPS, FED EX, etc.)
e-mail address
customer product preference information (e.g., pepperoni topping on pizzas)
customer ID verification (e.g., phone ID, voice recognition or PIN).
   This information is entered into the customer database as an information set for that particular customer.

A second database, product/merchant database 80, includes information corresponding to the order numbers assigned to each product offered through the system by the participating merchants. Each order number identifies a unique product and an associated merchant offering that product. Database 80 receives periodic updates from merchants M₁, M₂, . . . M_{N}.

Order transaction module 50 employs information from the product/merchant database for matching each incoming customer order to a participating merchant. Transaction module 50 also has access to customer information supplied from customer database 70 so that, in conjunction with order placement module 100, the necessary information may be communicated to the appropriate merchant to permit the merchant to fulfill the order. According to the embodiment illustrated in FIG. 3, communications to the merchants may be accomplished by a product order placement module utilizing, for example, a telephone/modem connection. A single server (e.g., an IBM RISC server) at the participating merchant's order receiving facility can receive tens of thousands of telephone/modem orders from system 20 per day. High volume merchants may choose to have dedicated phone line(s) for this purpose.

While not illustrated in FIG. 3, the participating merchant that will fulfill the order may confirm receipt of the order to the customer by electronic mail, mail, telephone or other suitable means.

In the embodiment of FIG. 3, the responsibility for verifying available credit and other aspects of handling credit transactions rests with the participating merchants.

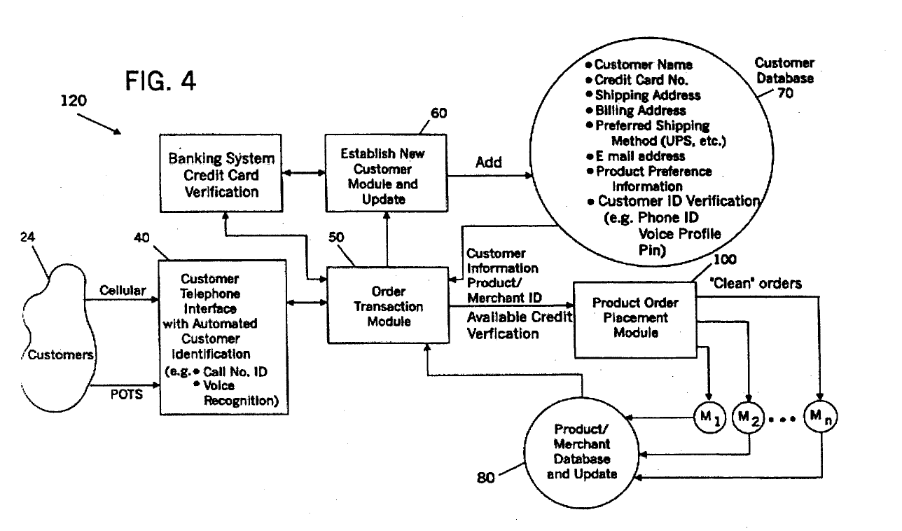

FIG. 4 illustrates an alternative automated order processing system 120 that is identical to system 20 of FIG. 3 except that the responsibility for verifying available credit of the customers is that of the operator of system 120. According to this embodiment, preferably the credit card information supplied by a new customer is verified through the banking system at the time the new account is set up through establish new customer module 60. Then, each time an order is placed by a customer with the typical credit card method of payment, the available credit is verified by system 120 so that the processed order sent to the merchant by product order placement module 100 is a “clean” order, ready for fulfillment and shipment.

FIG. 5 illustrates another automatic order processing system 220 that permits customers to not only order products, but also to order (usually free) information about products. For example, the advertisement of FIG. 3A may be modified to carry an additional line as follows:
For information only, enter information order number 24681357.
   A product information database 140 stores discrete information packages that may be ordered by system customers. When a product information order number is recognized by system 220, it is routed to product information request module 150 that calls up the requested information package from database 140 and transmits it to the customer by the customer's preferred transmission mode, as reflected in the customer's information set in customer database 70. Most typically, the information package is transmitted by e-mail, mail or POTS/voice, although other means may be used.

FIG. 6 illustrates another automated product order processing system 320 that also provides product information ordering capability, but the information request is simply processed like a product order and sufficient information is sent to the appropriate merchant to enable the merchant to fulfill the information request. For example, when a caller responds to an advertisement requesting product information only, system 320 processes the information order and sends customer information plus the identity of the information requested to the participating merchant through product or product information order placement module 100A. The merchant would then fulfill the customer's request for product information. It will be appreciated that a customer's information request serves as a “lead” in the hands of the merchant so that the merchant may utilize that information to follow up as appropriate with the customer. In this regard, the information order fulfillment system 220 discussed immediately above in connection with FIG. 5 may also operate so that all information packages sent out by module 150 are followed by a message to the appropriate merchants so that the merchants may have leads.

FIG. 7 illustrates an automatic order processing system 420 that provides shipping information and analysis for ordered products. Preferably, the shipping information is automatically presented to the customer when an order is placed for acceptance by the customer in accordance with either a “tone” or “voice” protocol. According to this embodiment, a shipper database 170 is provided for storing available shipping options through several shippers. Also, the product/merchant database 80A includes information concerning the size, shape, weight and other shipping related specifications of the offered products. The information in databases 170 and 80A are accessible to a shipment method wizard 190 that processes the information to provide speed/cost/shipper choices to order transaction module 50. These options may be communicated to the customer by a narrative such as that set forth in FIG. 3B.

FIG. 8 is a view of another automated order processing system 520 that permits the system to verify product availability to the customer at the time the order is placed. System 520 includes links to the merchants' inventory control computers so that the system can query the appropriate merchant when an order is placed to assure availability of the ordered product and that a tag is placed in the inventory control system to assure that the product is available for the system customer. This information link permits system 520 to confirm availability after the product order is entered by the customer through an automated voice message such as, “The product you ordered is in stock and will be shipped within 48 hours.”., As an alternative to the computer links of FIG. 8, the operator of the system may have a blanket policy known to merchants and customers alike that all orders that are accepted will be shipped within a set period of time, e.g., 72 hours. According to this implementation of the invention, the product/merchant database is updated by the merchants on an ongoing basis to place products on “back order”/unavailable status when they are not available, and to restore products to available status when they are back in inventory. Thus, all orders accepted by the system may be for available, in stock products. When a product is unavailable, the customer can simply be informed by an automated voice message such as, “The product you ordered is not in stock.”.

FIG. 8 illustrates a second additional feature whereby customers may access system 520 with a GPS capable device, for example, a cellular telephone with GPS capability. In this regard, global positioning systems are becoming more and more user friendly. They are so easy to use now that they can communicate a user's whereabouts with a simple click of a button. The knowledge of a person's whereabouts during an order to system 520 via cell phone or other device such as a PDA device, can provide some significant benefits.

When a customer who is traveling makes a connection to system 520, then the system can determine the closest geographic store or outlet location to forward to the appropriate participating merchant at the time of the sale so the merchant can perform the proper accounting and sales credit needed for the transaction.

When the customer's location, time of request and product selection coincide with an advertising campaign running at that moment in time and at the same geographic location as the customer, then the transaction can be sent to the merchant as verification of its advertising campaign's effectiveness. With this capability, merchants will be able to determine specific geographic responses to advertisements such as a certain advertisement run at a specific electronic billboard location in a near real time fashion.

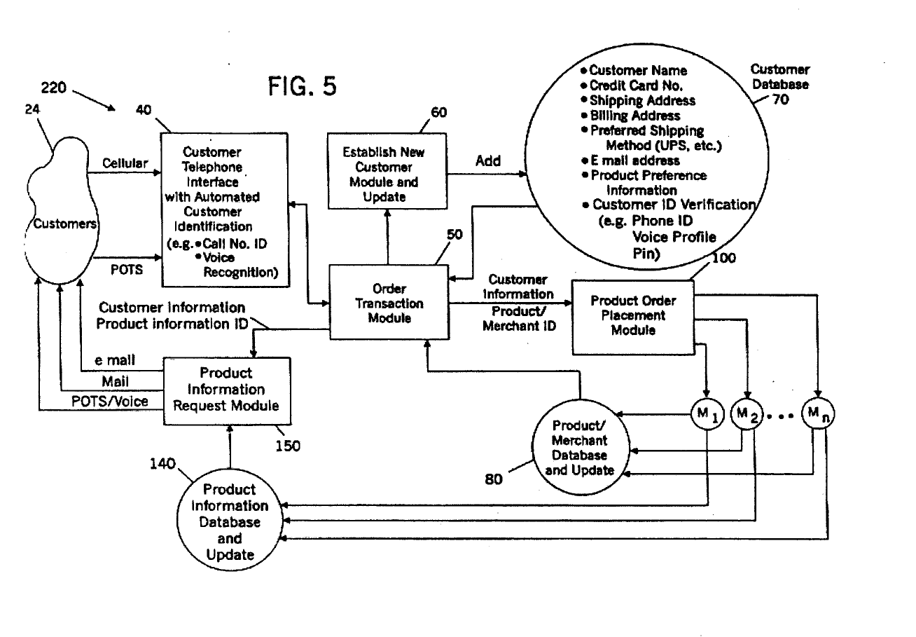

FIG. 9 shows a roadside electronic billboard display 230 displaying an advertisement for a CD recording offered through system 20. Because billboard 230 is at roadside, system access preferably is by preprogrammed cellular call or by cellular linking via an appropriate linking number such as “100”. Messages on roadside electronic billboard displays may be displayed for durations of say, one minute, and repeated as desired by the advertiser.

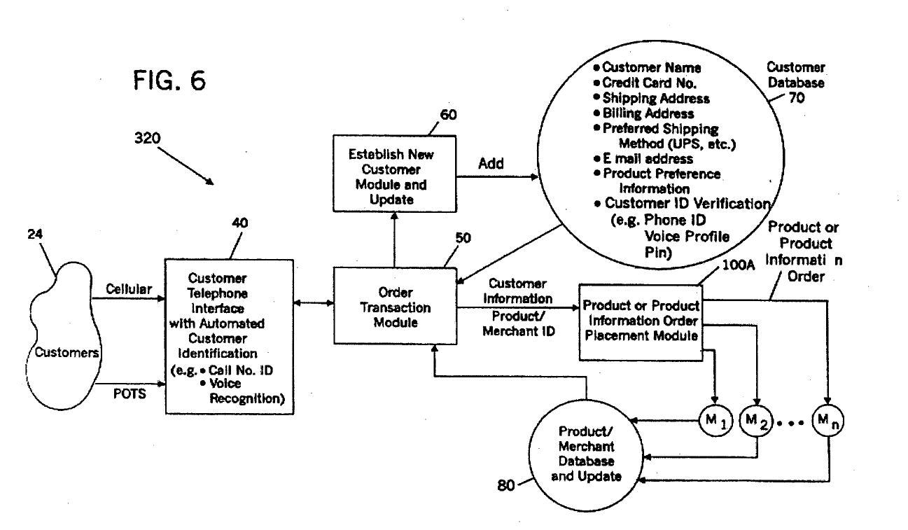

FIG. 10 shows another roadside electronic billboard display 240 with an advertisement for pizza delivery for commuters on a major roadway. As an alternative to offering only one topping for the advertised pizza, customers may be given the option to select toppings. As another alternative, topping preference may be stored in customer database 70 as product preference information.

It will be appreciated that automated customer ordering systems of the invention may be provided with a customer interface that permits customers to place an order using means other than POTS or cellular telephone. For example, the following communication methods, coupled with customer identification procedures, may be used, preferably to supplement a telephone access system:
satellite paging
personnel digital assistant (PDA)
radio LAN
satellite cellular.
   In this respect, the system operator may provide system customers with small, dedicated devices that permit direct system access and ordering, for example, by simply entering or speaking the order number into the device. These devices may employ satellite paging, PDA or other communications technology.

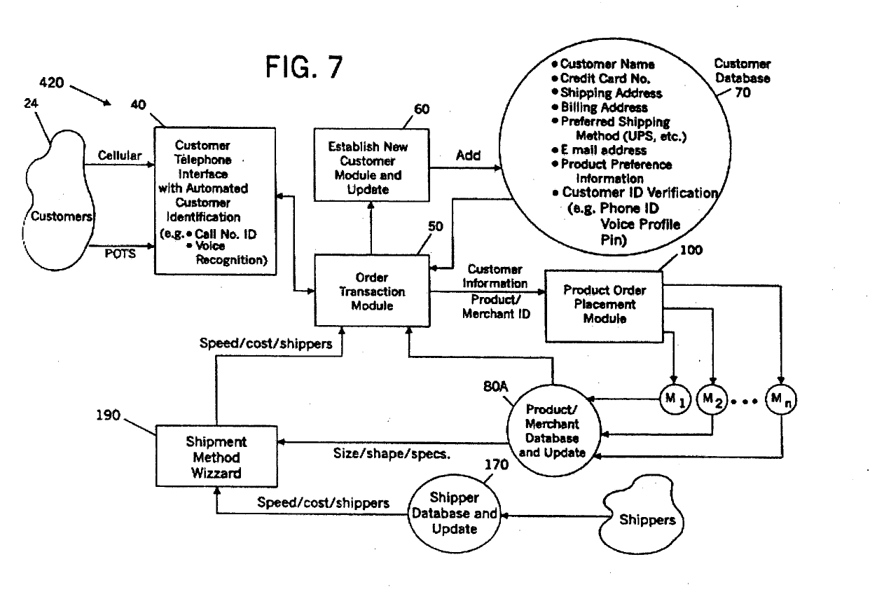

One business model for the commercial exploitation of the automated product ordering system of the invention is shown in block diagram form in FIG. 11. According to this model, the parties most directly involved are the system operator, system customers, participating merchants, shippers and the banking system/credit card companies who interact with each other as shown, all in accordance with interrelationships described above.

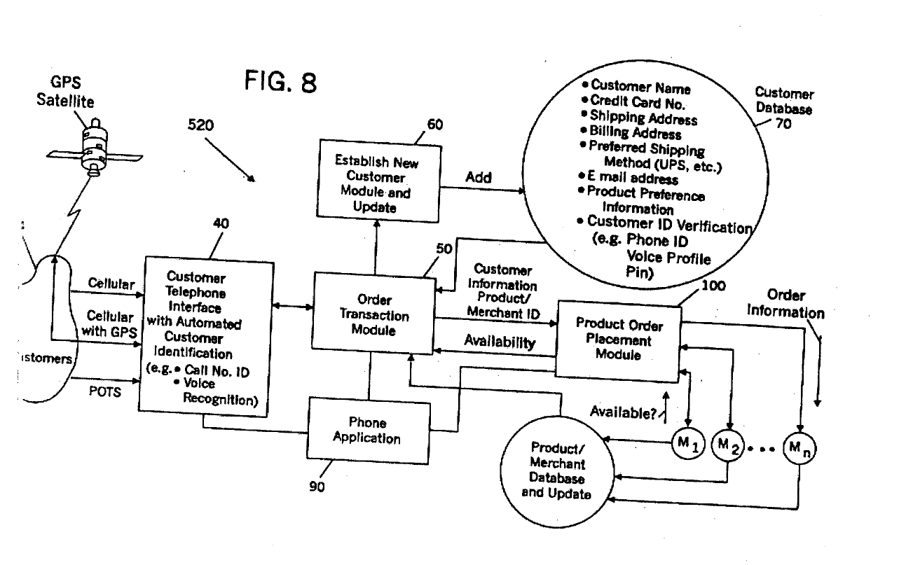

An example of the significant improvement the system of the invention offers over existing ordering systems is illustrated in FIG. 12 where for a major product or service category such as selecting a long distance carrier, the order number is a single digit. In this example, customers are shown a new discounted rate plan on an electronic billboard display and only have to press the preprogrammed “WT” button or WT speed dial and then one other digit to select a new long distance carrier. In the most powerful embodiment of this example, the customer presses the WT button on his phone and then simply speaks the number 8 into his phone and his phone service will automatically be switched to AT&T. When used with an embodiment employing voice recognition technology, independent verification of customer identity is not necessary because voiceprint identification provides secure confirmation that the switch to AT&T is authorized. This example illustrates the power of this invention to provide consumers the ability to respond to new pricing and products immediately, with very little effort. This capability is particularly important in large single product or service categories such as the long distance market where hundreds of billions of dollars are spent in the United States every year.

It will be appreciated that the order processing system operator may offer revolving credit to customers of the system, thus providing the system operator an additional profit stream and an additional mechanism for providing “clean” orders which do not expose participating merchants to credit risks, an option that is particularly appealing to small, niche vendors who may wish to utilize the system as their sole or primary order placement vehicle.

It will also be appreciated that the present invention has been described in connection with an automated order processing system for products. In this regard, the term “products”, as used in the specification and claims, is deemed to include both goods and services offered by participating merchants to customers of the system. Additionally, the invention may be used to process other kinds of transactions such as a situation where a non-profit organization advertises for donations and provides donors the opportunity to make monetary contributions through the system, or where an organization permits a customer or client to pay an invoice (with associated order number) through the system. Such donation transactions and invoice payment transactions and other transactions where one party (the “merchant”) permits another party (the “customer”) to pay through the system are deemed to involve “products” as that term is used herein.

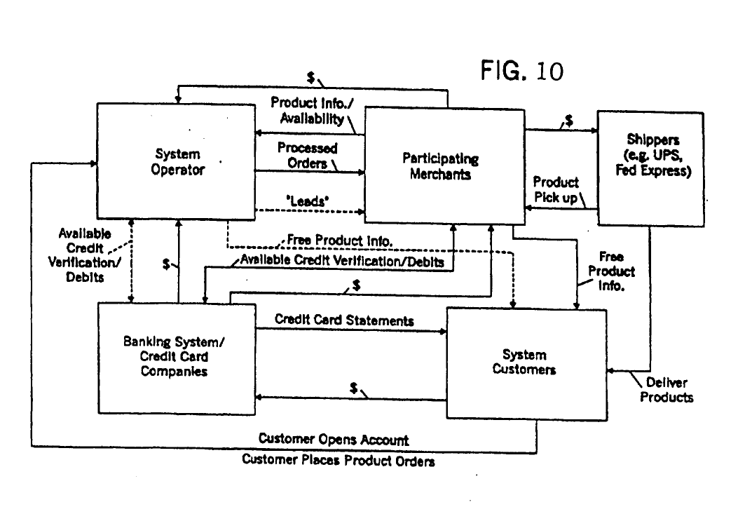

With the large number of product/merchant combinations for products made available through the system, most of the product order numbers will be in the range of 6 to 10 numbers. However, for certain, very high usage situations, or products particularly appropriate to a specific customer base, truncated product order numbers, even single digit numbers as discussed in connection with FIG. 12, may be utilized to facilitate transactions. One example of a number hierarchy based on 10-digit codes is provided in FIG. 13, below. In this example, the ten single digit codes (0 through 9) are reserved for use in very large single product categories such as the example for selling long distance telephone service illustrated in FIG. 12.

Referring to FIG. 13, the number of merchants is set forth in the first column with the number of digits used to define each merchant in the second column. The corresponding third column shows the maximum number of product order number combinations available to each merchant in a ten digit code that includes the digits used to define each company or merchant. In this example, merchants may assign shorter or truncated product codes for higher volume products, thereby creating total code lengths that would typically vary from 3 to 10 digits. Maximum number of product combinations are assigned to companies based on size and product offerings. For example, the very largest global companies that offer many products, components and services would be assigned very large maximum product code combinations. The hierarchy of code assignments would thereby allow system 20 to process both retail and business-to-business sales. The larger company codes having from 8 through 10 digits would be utilized primarily by professionals that offer fewer or, in many cases, even a single product or service. One powerful example is attorneys, accountants and consultants utilizing a single code for any service they offer, allowing their customers to simply dial one code provided on each invoice to automatically pay their bills. The number hierarchy shown in FIG. 13 is one example of how the distribution or assignment of numbers can be made. Other hierarchy or distributions may be utilized. For example, number hierarchies having maximum code lengths of eight, nine, eleven, twelve, thirteen or fourteen digits may utilize the structure of FIG. 13 for hierarchial relationships between number of companies (“merchants”), company digits, product digits available and maximum product combinations per company.

The order processing system may have application at any scale of operations (as measured by number of participating merchants, volume of orders, dollar volume, etc.) that is economically viable; however, it will be appreciated that one primary utility is the provision of a universal automated product ordering system that is known to virtually all consumers in the modern economy and permits consumers to first join the order processing system and thereafter purchase any offered product any time through a simple, fully understandable, non-intimidating access and ordering procedure that may be as easy as pushing one button (followed by entry of an order number) on a POTS telephone, cellular telephone, PDA, pager or a dedicated device.

From the above detailed descriptions of both the electronic billboard display and the automated order processing aspects of the invention, it will be appreciated that they combine to offer a powerful new merchandising tool that benefits merchants, consumers and the economy as a whole.

While the present invention has been described in connection with certain illustrated embodiments, it will be appreciated that modifications may be made without departing from the true spirit and scope of the invention.

1. A merchandising system permitting participating merchants to place video or still-image advertisements at selected times and locations on a network of multiple electronic billboard displays, and permitting customers of the merchants to respond to the advertisements by directly placing orders for advertised products through an order processing system, said merchandising system comprising:
a network including a plurality of electronic billboard displays;
means permitting participating merchants to place video or still-image advertisements at selected times on selected ones of the network's electronic billboard displays;
the advertisements on the displays including a unique product order number for each product offered for sale by the participating merchants; and
an order processing system that permits customers to order products from the array of products offered by the participating merchants on the electronic billboard display advertisements, said order processing system including a customer interface for receiving incoming orders from customers ordering products by reference to the displayed product order numbers, means for matching each incoming product order to the customer placing the order, the product ordered and the participating merchant offering the product, and means for communicating sufficient customer and product information to the participating merchant so that the merchant can fulfill the order.

2. The merchandising system of claim 1 wherein said means Permitting participating merchants to place advertisements includes a central Processing station to which merchants transmit their advertising content and means for routing the advertising content for display at the merchant-selected electronic billboard displays.

3. The merchandising system of claim 1 wherein said customer interface for receiving incoming orders from customers comprises a telephone interface including automated customer identification means.

4. The merchandising system of claim 3 wherein said automated customer identification means is selected from the group consisting of call no. ID and voice recognition.

5. The merchandising system of claim 1 wherein at least a portion of the customers ordering through the order processing system utilize a GPS capable device and said order processing system employs GPS means for determining the location of customers during the customers placement of orders.

6. A merchandising method permitting participating merchants to place video or still-image advertisements at selected times and locations on a network of multiple electronic billboard displays, and permitting customers of the merchants to respond to the advertisements by directly placing orders for advertised products through an order processing system, said merchandising system comprising:
permitting a participating merchant to place video or still-image advertisements at selected times on selected electronic billboard displays;
including in the advertisements a unique product order number for each product offered for sale by the participating merchants;
each customer, when desiring to place an order for a participating merchant's advertised product, establishing contact with a central order processing system and entering the order number for the product desired; and
the central order processing system matching each incoming product order to the customer placing the order, the product desired and the participating merchant offering the product, and communicating sufficient customer and product information to the participating merchant so that the merchant can fulfill the order.

7. The merchandising method of claim 6 including the step of at least a portion of the customers placing orders for advertised products establishing contact with the central product ordering system by GPS capable devices and communicating the customers' locations to the order processing system during placement of orders.
